(19) United States
(12) Patent Application Publication
(10) Pub. No.: US 2010/0211579 A1
(43) Pub. Date: Aug. 19, 2010

(54) System and Method For Providing Expert Search In A Modular Computing System

(76) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/707,203

(22) Filed: Feb. 17, 2010

Related U.S. Application Data
(60) Provisional application No. 61/207,980, filed on Feb. 17, 2009.

(51) Int. Cl. G06F 17/30

(52) U.S. Cl. 707/754; 707/749; 707/736; 707/E17.059; 707/E17.069

(57) ABSTRACT

The present invention provides an apparatus, system and method for a dedicated function, modular computing solution. The apparatus, system and method include a base microprocessing unit, at least one peripheral interconnective with the base microprocessing unit, wherein the at least one peripheral alone imparts the dedicated function to the base microprocessing unit, and a limited function operating system provided with the base microprocessing unit, wherein the limited function operating system accepts a first application for at least partially operating the at least one peripheral provided with the at least one peripheral, and wherein the limited function operating system includes a second application for seeking topical information, regarding a topic searched, that is recommended by one or more qualified experts in the topic searched.

### CROSS REFERENCE TO RELATED APPLICATIONS

The present application claims priority to U.S. Provisional Application No. 61/207,980 entitled “System and Method for Providing Expert Search In a Modular Computing System,” filed Feb. 17, 2009, the entire disclosure of which is incorporated by reference herein as if set forth in its entirety.

### BACKGROUND OF THE INVENTION

1. Field of the Invention

The present invention relates generally to computers and computing applications and, more particularly, to an apparatus, system and method for providing expert search in a modular computing system.

2. Description of the Background

At present, typical home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. Further, in the event the purchaser wishes to make a change in that which he or she will make use of in a “one size fits all” computer presented for purchase, the purchaser must typically either request such change at the time of purchase of the computing system, or must have sufficient expertise to make the desired modifications him or herself subsequent to purchase, or must be willing to make significant expenditures after purchase to have another make the desired modifications.

Further, at present, typical keyword searches entered into a search engine cause the performance of a web crawl, wherein the best matches to the keywords searched that are located by the web crawl are returned as the search results. However, the matches returned via this methodology often poorly matches what the user intended to locate via the user's search. The poor matches are frequently reflective of the fact that different search terms can mean different things to different people—that is, people having different demographic or personal characteristics may have similar views of what would constitute relevant results to a user search. Available search engines fail to take advantage of this similarity of certain users in order to enable improvement in search results.

Additionally, although the prior art may make available the re-use of a prior search by a searching user, such re-use of a search is not likely useful unless the prior searcher had a greater expertise in the area searched than did the present searcher. Thus, existing search engines fail to make use of the expertise of others in endeavoring to return the best search results for a searching user. Further, there is no advantageous search solution that solves the aforementioned problems and is specifically operable in a modular computing system

Therefore, the need exists for a life style oriented computing solution that provides a modular computing solution in an open platform format, and that thereby provides a search engine, system and method that returns search results based on those results deemed most useful by experts in the field searched, and that allows for results to be filtered based on those experts most similar to the searching user in demographic and personal information.

### SUMMARY OF THE INVENTION

The present invention provides an apparatus, system and method for a dedicated function, modular computing solution having an expert search capability. The apparatus, system and method include a base microprocessing unit, at least one peripheral interconnective with the base microprocessing unit, wherein the at least one peripheral alone imparts the dedicated function to the base microprocessing unit, and a limited function operating system provided with the base microprocessing unit, wherein the limited function operating system accepts a first application for at least partially operating the at least one peripheral provided with the at least one peripheral, and wherein the limited function operating system includes a second application for seeking topical information, regarding a topic searched, that is recommended by one or more qualified experts in the topic searched.

Thus, the present invention provides a life style oriented computing solution that provides a modular computing solution in an open platform format, and that thereby provides a search engine, system and method that returns search results based on those results deemed most useful by experts in the field searched, and that allows for results to be filtered based on those experts most similar to the searching user in demographic and personal information.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates the execution of specialized searches;

FIG. 2 illustrates the creation of an online persona according to an aspect of the present invention;

FIG. 3A illustrates the display of search results according to an aspect of the present invention;

FIG. 3B illustrates methods of presenting search results;

FIG. 4 illustrates the ability to take search results and add keyword related favorites and tagging for future use;

FIG. 5 illustrates the presentation of certain feeds according to an aspect of the present invention;

FIG. 6 illustrates the ability to take the results and add keyword related favorites and tagging for future use;

FIG. 7 illustrates posting to a blog by entering a URL;

FIG. 8 illustrates posting to the user search results tab;

FIG. 9 illustrates using a user created widget to publish the user search results;

FIG. 10 illustrates additional exemplary results according to an aspect of the present invention;

FIG. 11 illustrates keyword searching to modify expert searches according to an aspect of the present invention;

FIG. 12 illustrates exemplary options of filtering a search;

FIG. 13 illustrates exemplary options of filtering a search;

FIG. 14 illustrates exemplary options of filtering a search;

FIG. 15 illustrates the selection of one of the experts produced responsive to a search;

FIG. 16 illustrates an experts topical page related to the search keywords;

FIG. 17 illustrates a block diagram of the hardware configuration of the present invention;

FIG. 18 illustrates a block wiring diagram of hardware according to an aspect of the present invention;

FIG. 19A illustrates a configuration of the hardware of the present invention; and

FIG. 19B illustrates hardware of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

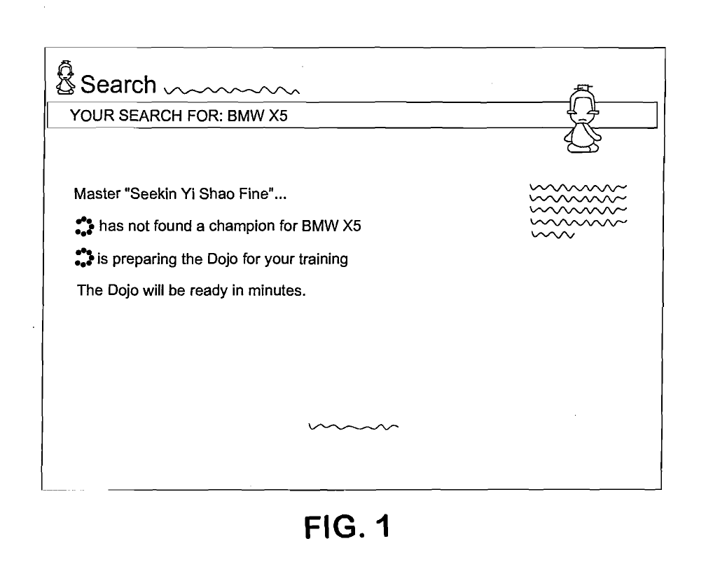

The present invention may allow, with or without the use of widgets and/or widgetized avatars, the execution of specialized searches. For example, as illustrated in FIG. 1, a user may execute a search. The search executed may search for a “master” in the area searched, such as a person having some increased level of expertise in the searched area in a particular environment, such as on one or more of the user's social networks, and/or may seek search results in accordance with those results found most useful by such “masters.” The social networks of a user, or a master, may be associated, for example, with an avatar.

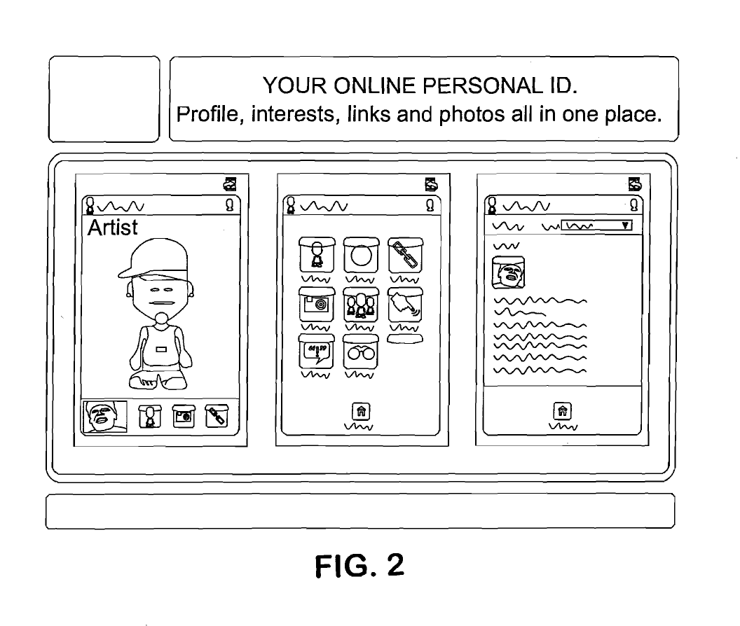

The present invention may thus include a fully portable, widgetized avatar having associated therewith multiple items of information and/or social information that may be generally searched for and/or otherwise requested for association with at least two different computing communities or transactions. Widgetization of the avatar of the present invention necessarily allows for portability of the avatar of the present invention. For example, creation of a typical avatar in accordance with the present invention may include the association of physical, such as facial and hair, features with the subject avatar, as well a user name, as shown in FIG. 2. Further, a myriad of additional information may be associated with the avatar, wherein such information is generally required or desired for use in computing communities or transactions, such as search transactions. This information may be organized into multiple levels of detail, and/or multiple levels of accessibility to third parties in a computing community or transaction. Such levels of accessibility may be selected by the creator of the widgetized avatar, and may be based on characteristics of the third party endeavoring to access the subject avatar. For example, a user may have basic information, which may be selectable for viewing by all registered users.

Needless to say, because the virtual manifestation of a user as an avatar or the like is embodied in the computing code that provides for the virtual manifestation, such computing code may be accessible via linking to the virtual manifestation, such as to the avatar or a home or base page for the virtual manifestation. As such, the virtual manifestation(s) of others may be returned upon a requested search, and, based on the rated expertise level in the area searched, such virtual manifestations may be ranked responsive to the search. In fact, a resultant “expert” may have multiple pages available for linking to upon searching by another user, wherein each such page may relate to a different topic or area for searching, and therefore wherein each such page may merit a different expertise rating for the user having such pages.

Those skilled in the art will understand that such virtualized manifestations may be provided in a normalized format such that it is easily adopted into multiple computing communities, and/or may be adopted as non-static content onto multiple different web pages. As such, the subject virtual manifestation may be incorporated, responsive to a search, into the search results for multiple social communities, fantasy sports communities, blogs, and the like. Further, virtual manifestations of particular interest to the general public, such as those of musical artists, other famous persons, or “hot” search terms, may be have widgets associated with such virtual manifestations downloaded, added to user hot pages, or otherwise referenced by fans of such famous persons. As will be understood by those skilled in the art in light of the discussion herein, and in part due to the fact the certain characteristics of the searching user may be known to the search engine of the present invention, the downloading of widgets in accordance with the present invention allows for a monitoring of who performed a search, what they deemed most relevant responsive to it, and what was done responsive to that relevance, such as the downloading of a widget. Thereby, the present invention may include an advanced marketing and sales tool.

Additionally, such “famous” virtualizations for hot search results may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

A virtual manifestation, in accordance with the present invention, may thus allow for keyword based searches to be performed in one or more search environments and/or on one or more computing communities, and/or or across one or more computing communities, i.e., social networks. For example, as discussed hereinabove, a virtual manifestation, such as an avatar, web page(s), or search result page, in the present invention may have associated therewith a series of unique personal information indicative of the user associated with the virtual manifestation. Such personal information may include interests, likes, dislikes, which in some may lead to a characterization of expertise in one or more such areas of interest, like, or dislike which expertise may be associated with the virtual manifestation. Thereby, not only may the user's virtual manifestation travel with the user from computing community to computing community, the user's expertise classifications may likewise travel with the user from computing community to computing community.

Needless to say, typical keyword search engines are understood to those of ordinary skill in the art. Such an engine may be available in a particular computing community, or a search feature may be made available across multiple computing communities, and such a multi-community search engine may, for example, for security purposes, allow a particular user to search only those communities of which that user is a member. Keywords may be entered by a searching user in freehand, or a list of available keywords for expertise searching may be presented to the user for selection of a particular keyword or keywords.

The expertise attribute, and other attributes, may either be entered by the user correspondent to the virtualization to which the expertise rating is assigned, or may be assigned algorithmically, such as by the computing community or across multiple computing communities. For example, as a certain user obtains ever increasing positive feedback, or as a certain user is returned more frequently responsive to a search for expert in a certain area, that user's expertise rating may increase. Alternatively, a user may submit external information to a computing community to prove that user's level of expertise, and the computing community may respond in kind by assigning a particular level of expertise to that user.

In the prior art, subsequent users may, in certain embodiments, access and/or make use of prior searches by prior users of a search engine. However, even in such instances, the subsequent user has no way of knowing of the expertise level of the prior searching user, that is, the subsequent user has no way of knowing if the prior user was an expert, or at least had sufficient expertise to make reusing his or her search worthwhile. More particularly, the logic of the prior art is flawed, at least in that a true expert in a particular area is unlikely to employ base level searches in a typical search engine. Rather, a true expert in a particular area is likely to have record of, such as by bookmarking, live-linking, or having a page dedicated to, particular links or points of interest that that expert has found helpful. Thus, it is far more useful for the subsequent user to search for an expert or an expert's results, and then make use of the expert's recommended information or search points, than it is for the user who is a non-expert to formulate his or her own search, or reuse a prior search that may or may not have been performed by an expert. Thereby, the present invention allows for the conversion of a traditional search into a dynamic search far more likely to produce useful information to a user, at least based on the fact that the search will lead to the location of a known expert in the field searched.

Additionally and alternatively, experts in particular fields may advertise their expertise, such as wherein his or her expertise has been verified by the computing community, and a searching user may search such “advertisements” in order to locate a known expert in a particular field. Thus, a search in the present invention may produce the virtualization and social information of an expert, may produce an advertisement from an expert, and may produce search result information known to be used by experts or particular experts, or the like.

Further, it will be apparent to those skilled in the art in light of the disclosure herein that unique expert rating systems may be employed, and/or that experts meeting certain criteria may be assigned unique, interesting, amusing, or the like ratings. For example, a particular computing community may assign an introductory level expert a “white belt” if that user is an expert in a particular area, and may assign a different rating if that user is an expert in another area, or may assign the white belt rating to all introductory experts in all areas. Of course, in such an exemplary embodiment, successively greater experts would be assigned successively higher ratings such as green belt, brown belt, and black belt for the highest rated experts in the above white belt example. Likewise, rating systems may be or include unique nomenclature for different possible areas of expertise. For example, automotive experts may be assigned ratings such as weekend warrior mechanic, mechanic, master mechanic, or Mister Goodwrench® for the highest level expertise with regard to automobiles. Needless to say, expertise in certain particular areas, such as automobiles, may be further hierarchically broken down, such as by type of automobile, year of automobile, manufacturer of automobile, or the like.

The present invention may offer an experts arena, wherein different experts arenas may be available for different areas of expertise. Within an expert arena, the searching user may find topical discussions, such as blogs, between certain experts, or may find lists of experts, or may find lists of experts broken down by level of expertise. Further, such an arena may include indexed information based on the use of that information by experts, and/or based on the ratings of the experts that use such information.

Thus, the present invention, at least in part, may provide searching based on the relevancy of a person's expertise to a desired topic on which help is sought, rather than the prior art methodology of keyword searching relating not to people and/or experts, but instead relating merely to websites, things, or advertised services that have no expertise rating associated therewith. Of course, this embodiment of the present invention allows the keyword revenue model of prior art search engines, such as Google®, to be employed in the monetization of searching for true experts that can assist in topical areas, and/or expert information in those topical areas, associated with the particular keywords searched.

As such, the present invention provides a recommendation engine. The recommendation engine may integrate a particular virtualized identity and/or manifestation, along with a webtop, desktop, search results application, social network, and/or other type of computing community, to allow for suggestion of content, information, or physical experts based on a user's expertise as assessed from that user's community, that user's other communities, that user's popularity, that user's feedback, that user's click stream, that user's interest, that user's prior accessed information, or that user's searches or search results. Such information may allow for an expertise rating that may be assigned by the computing community, or that may be used by users to identify themselves as experts in certain areas, which may further allow such users to populate an advertisement, results page, web page, web forum, applet, widget, or the like that will readily allow searching users to search and find that expert and/or that expert's recommended results.

Thus, in accordance with the exemplary embodiments set forth herein throughout, the present invention provides an intersection between keywords and expertise in those keywords. As will be apparent to those skilled in the art in light of this discussion, similarities among users increases relevancy for keyword search results, particularly in localized, such as geographic or topical localization, searching, and the advantages gained from this similarity are further heightened when one of the users wishes to gain from the expertise of a similar user in a desired area. Such expertise-based keyword searching is particularly useful in areas in which such unique expertise would generally improve search results, such as in, but not limited to, geographic locality, travel, health, entertainment, cars, lifestyle, education and commerce, for example.

In an exemplary flow of the present invention, and returning now to FIG. 1, a user-entered search causes the execution of a search, and the user may be presented with a unique page while search results, which preferably include expertise-based information and/or experts in the area searched, are dynamically built. The dynamically generated results page may be presented in any number of formats, such as in a searchable blog format.

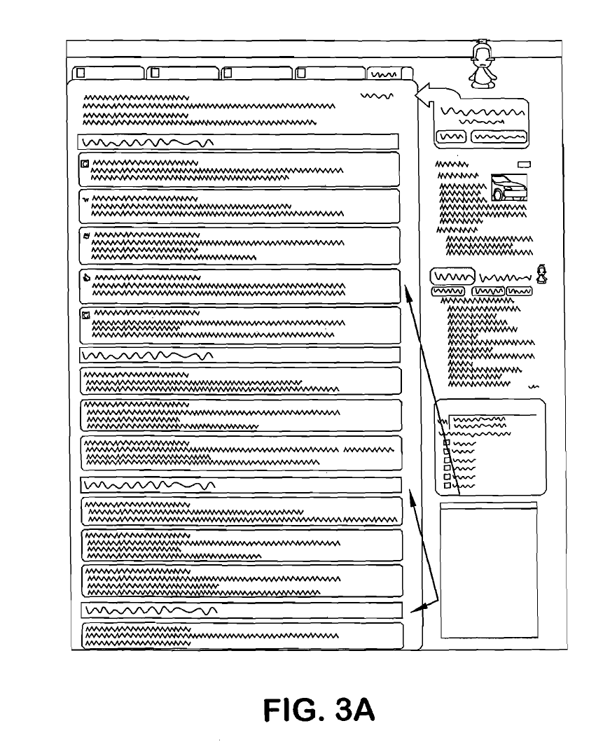

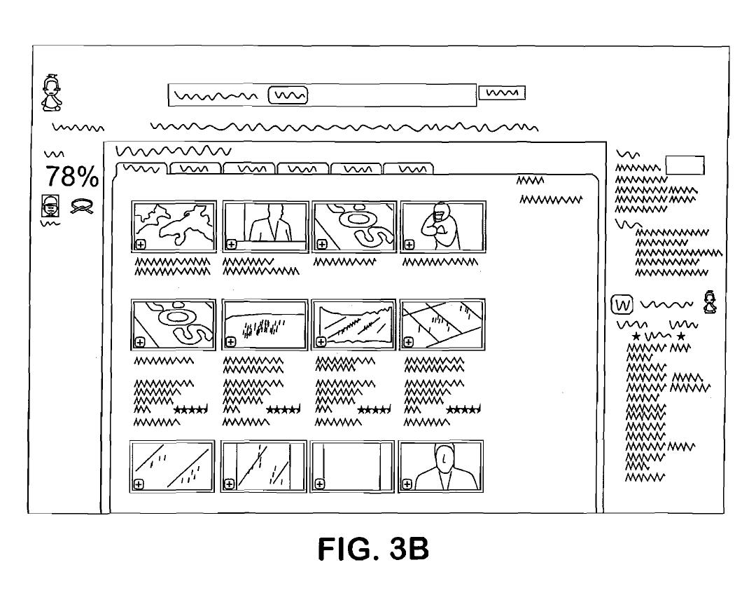

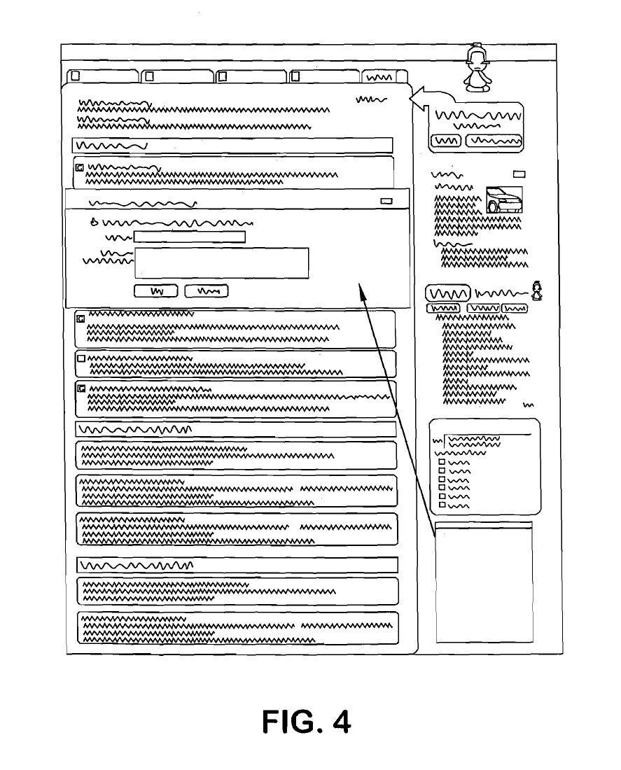

For example, search results may be presented as illustrated in FIG. 3A. The search result presentation illustrated does not include presentation of particular experts in the area searched, but does include an accessible linking, such as via the illustrated tab or a drop down menu, for example, to experts in the search area, (which, in this exemplary embodiment, was an automobile, and more particularly a “BMW X5”), and does include links, organized conveniently by category (i.e. “Top 5,” “Recent News,” “History,” and Current Models,” for example). The links presented may preferably be those found most useful by users having greater expertise in the area searched than the searching user to whom this results page is presented. Further, categorical arrangement of the results allows for a user to “refine” the search by particular areas that may have been of most interest to the user, but that may not have been included in the search keywords. Further, the results page may include brief information assessed by experts on the search keywords, may include the day's top searches generally, and may include a sharing tool through which the searching user can share search results, experts, or expertise in one or more computing communities, such as those computing communities of which the searching user is a member. Additionally and alternatively, FIG. 3B illustrates methods of presenting search results, such as by providing tabs wherein the searching user may click different tabs to view different types of search results. Additionally and alternatively, a user may be able to take links returned and add to keyword-related favorites, tag for future use, and/or add expert's quick note comments for future users, as illustrated in FIG. 4.

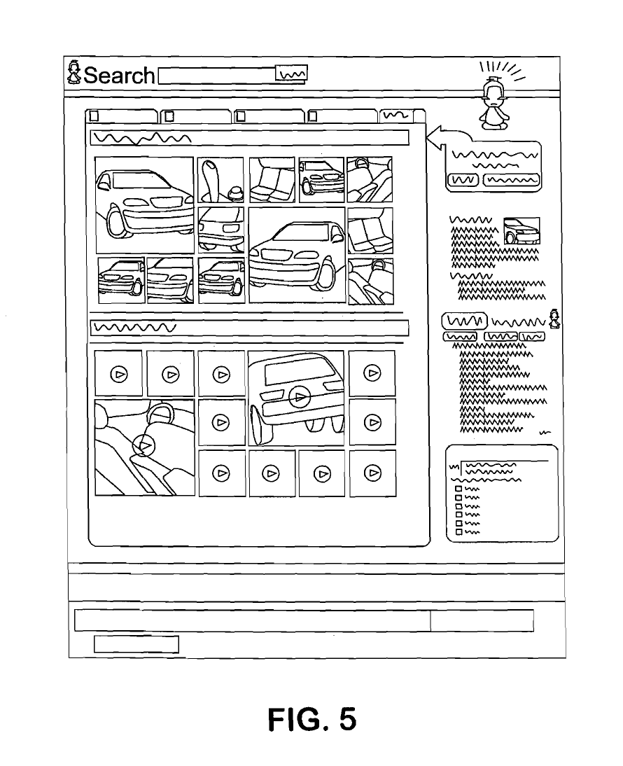

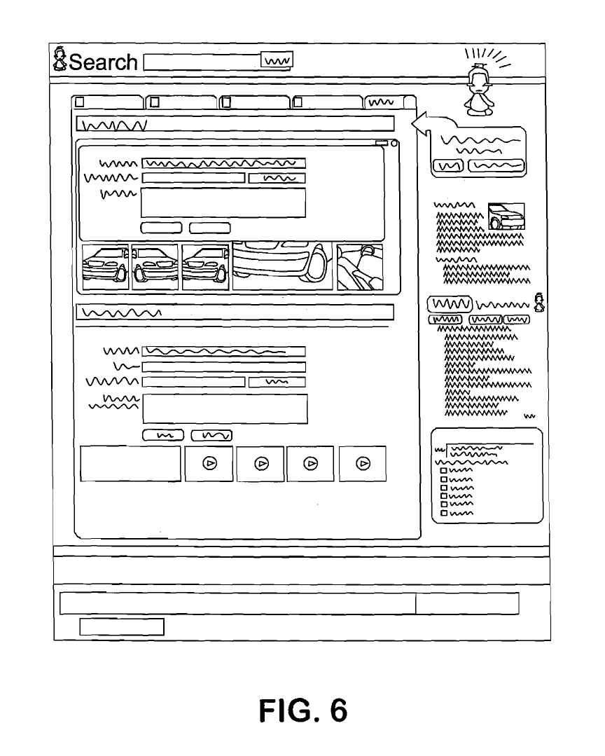

Other categories, such as photos, videos, blogs and the like related to the search keywords may also be categorically presented, for ease of locating by the searching user, and in fact may include presentation of snapshots, thumbnails, mouse-overs or the like to allow a user to assess relevance or desirability from the results page, and without actually entering the presented link. The feeds presented may be, for example, RSS feeds, YouTube feeds, or the like, as illustrated in FIG. 5. Further, as was the case with the links presented hereinabove, the searching user may edit, upload, tag, change, or recommend any picture or video box, as illustrated in FIG. 6.

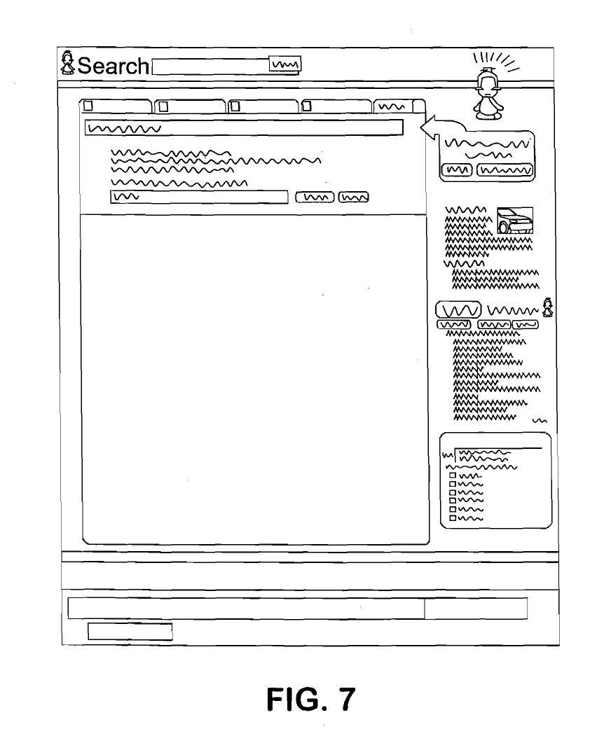

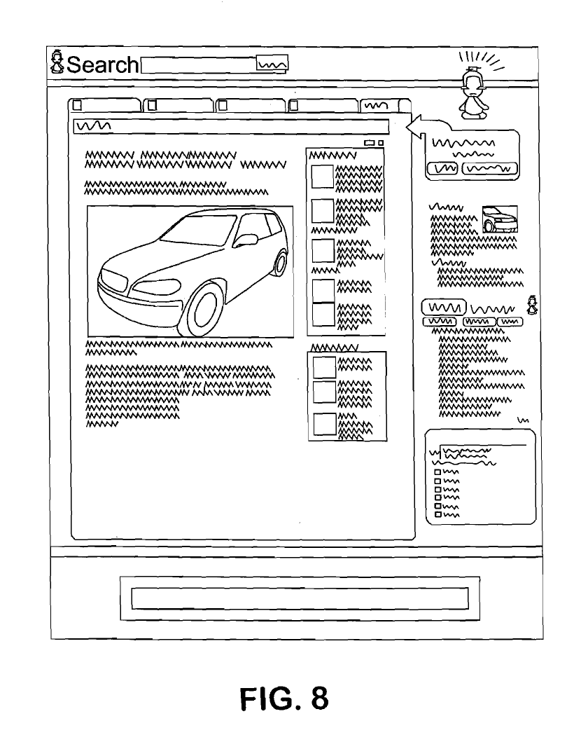

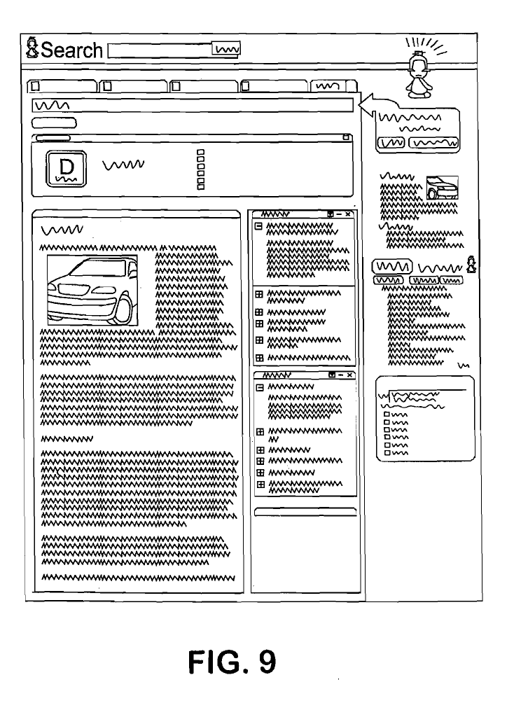

In fact, in a manner similar to the photo and videos discussed hereinabove, the searching user can additionally post his or her blog simply by entering the URL, as shown in FIG. 7. Thereby, the searching user's blog may be posted to the user's search results tab, as illustrated in FIG. 8. For example, the user's blog, or one or more blogs of interest to the user, and additionally or alternatively pictures, videos, music, and/or interests of the user, may be employed to create a widget, which user created widget may likewise be published to the user's search results, as illustrated in FIG. 9. Similarly, widgets returned responsive to a search may be downloaded by a user, such as to the user's desktop, or other user's page of interest, such as a MySpace page or the like.

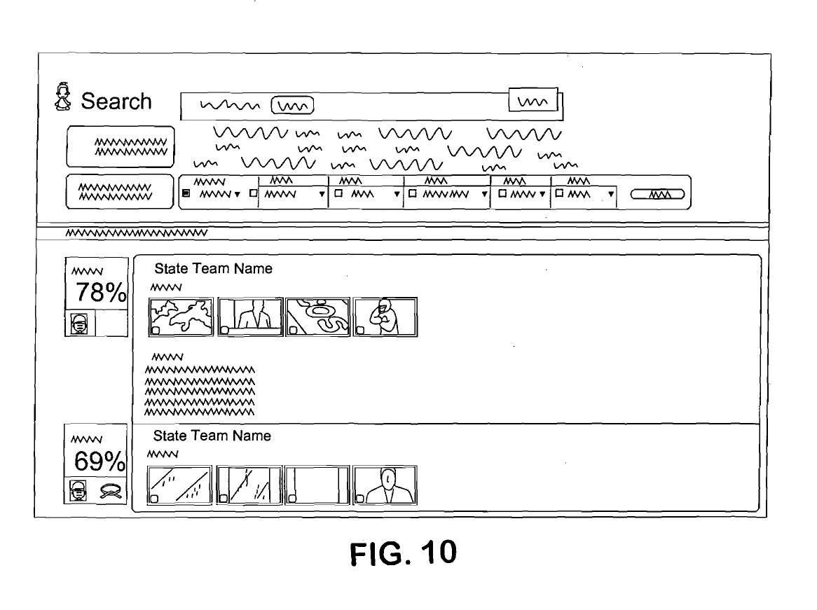

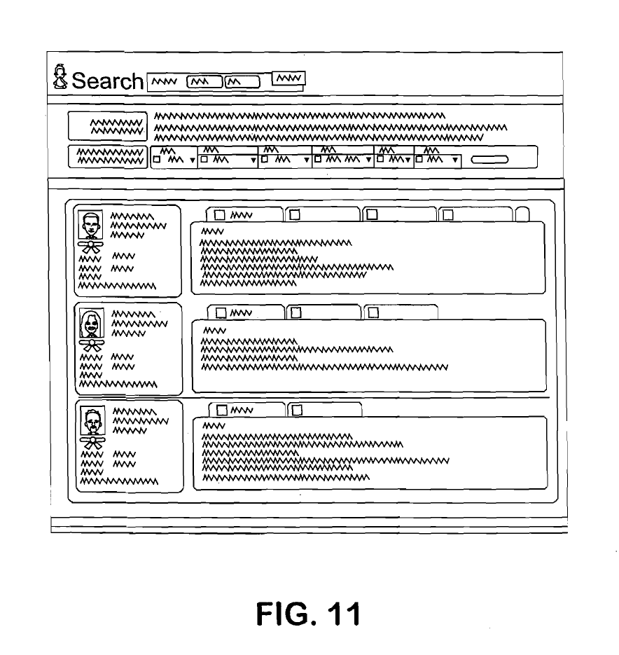

An additional exemplary results page is presented in FIG. 10. FIG. 10 illustrates search results for keywords “Denver Broncos” and “Videos.” Of note, this search has returned principally videos, operating under the assumption that the user has searched videos because the user wishes to see videos, not be presented, for example, with textual information related to videos. This assumption may be made, in accordance with the present invention, based on an understanding of what such a combinations of keywords would mean to an expert specifically in the area of the search keywords. Of further note in FIG. 10 is the “tag cloud” presented at the top of the search results. The tag cloud in the present invention may, for example, be generated in accordance with information, such as custom tabs, and associated with experts in the fields of the keywords searched by the searching user. As such, unlike prior art search mechanisms, selection of additional keywords from the tag cloud for inclusion in the subject search actual increases the relevance of search results, in a manner similar to a linguistic search. Further, each keyword, and each additional keyword, may modify the expert matches for the search, as displayed along the left column of the search results in the illustrated examples of FIGS. 10 and 11, in real time. Such expert matches may, of course, include matching factors, such as percentage match of the expert to the search terms, search terms plus any filters, etc., expert rating, expert views, and freshness of the match, for example.

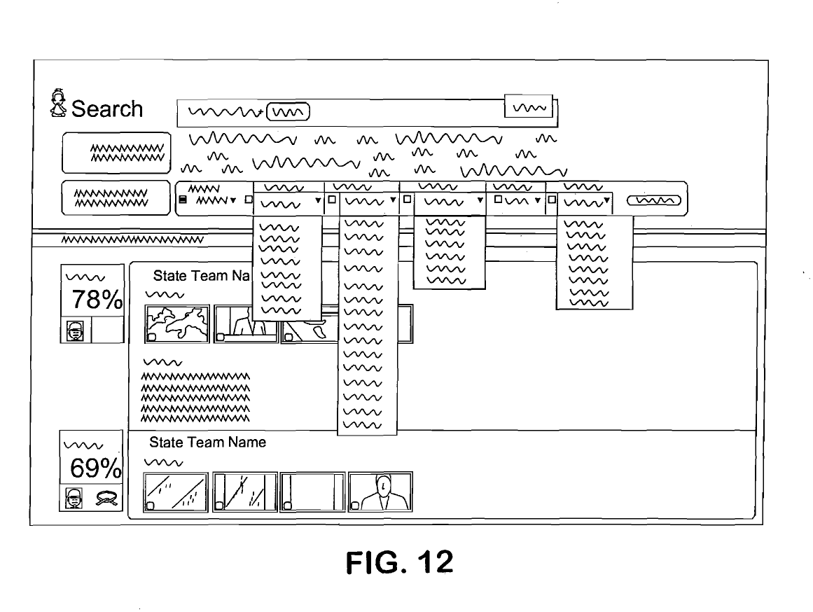

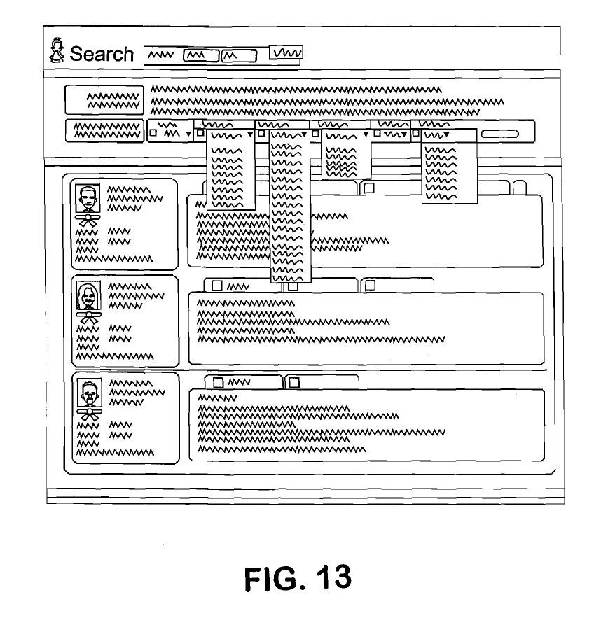

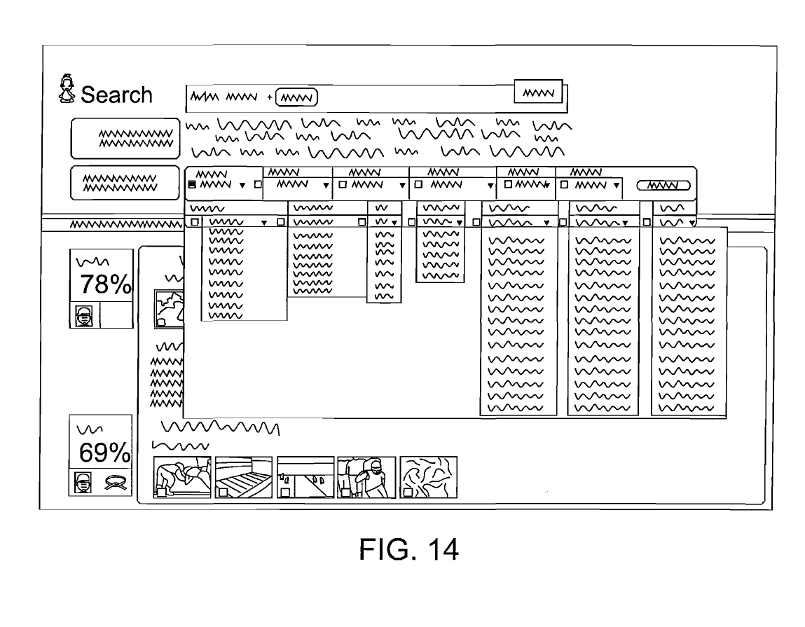

Additionally, FIG. 10 illustrates, under the tag cloud in this, exemplary embodiment, the filtering made available in the search of the present invention. Filters may, for example, provide additional touch points about the searching user that are relevant to the searching user and his or her search that help the search produce experts that match the user's demographics. For example, filtering a search by the gender, age, education and income of the searching user in the present invention, which are several of the exemplary options illustrated in FIGS. 12, 13 and 14 increases the relevance of the experts used by the present invention to produce the search results. Thereby, the present invention provides additional layers to produce increasingly relevant search results. Further, as illustrated in FIG. 14, certain of the available filters may be hidden in order to improve presentation for the user, and such filters may be selectable by the user to be presented in addition to first layer filters, such as by clicking a “More” tab or button. Different layers of filtering may be hierarchically interdependent, or may not be, as will be understood by those skilled in the art. For example, a “Religious affiliation” Tab may drop down to present “Christian” as one of the option, and a second layer of interdependent filtering may present different options of Christian religions in the event the “Christian” tab is selected, such as “Lutheran,” Methodist,” etc. In light of the discussion hereinabove, the present invention does not produce search results using any type of web-crawling algorithm, but rather produces search results by matching people, interests, demographics, and the like.

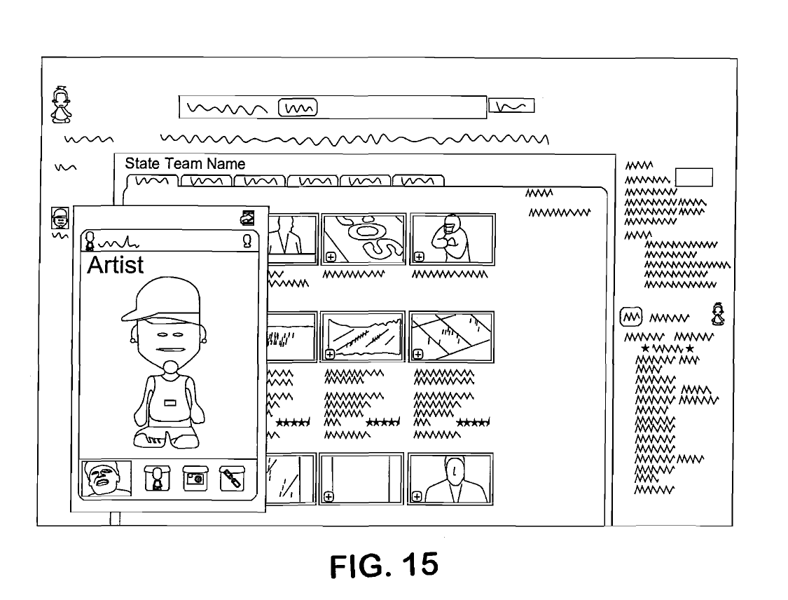

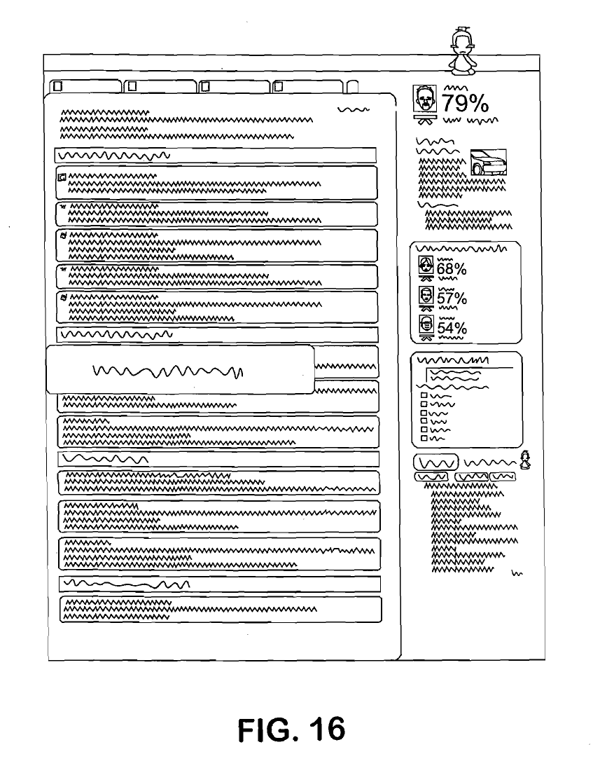

FIG. 15 illustrates the selection, by the searching user, of one of the experts produced responsive to the search. FIG. 16 illustrates that, upon selection of an expert page responsive to a search, that expert's topical page related to the search keywords is produced. In the illustrated embodiment, Bobby Beemer is an expert in BMW automobiles and, based on his assigned percentage, is the best matched expert by topic and demographics and filters to the searching user. Also maintained on the expert's result page, as illustrated in FIG. 16, are the other available expert matches for the user's search. Thus, with a single click, if the searching user deems Bobby Beemer's page in the exemplary embodiment to be unhelpful, the user can explore the expert's pages of other matching experts to the initial search. Preferably, the searching user can thus explore the results from multiple experts on the topic search without returning to the user's main search page to explore the results of each different expert.

Needless to say, the search capabilities of the present invention may be employed in conjunction with more typical prior art search capabilities, such as a web crawler, to increase the richness of the search results produced. In such an exemplary embodiment, the results of the present invention and a prior art type search may be presented to the user seamlessly and simultaneously, or may be produced separately to allow the user to assess which methodology has produced the most relevant results. Those skilled in the art will understand that, in the event a searching user is allowed to select between the results of multiple different search types, the type ultimately selected should be indicative of which search method produced the more relevant results. Thereby, tracking which result set is selected by the searching user may be algorithmically employed by the present invention in order to further improve the search results produced by the present invention.

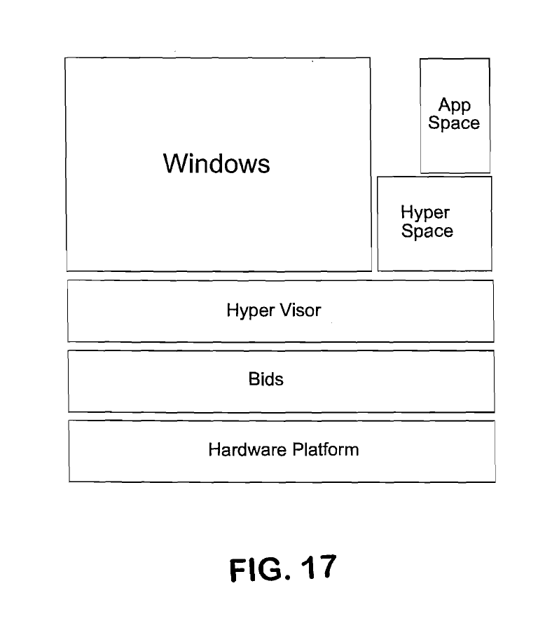

The search capabilities of the present invention, in addition to and as part of the virtual manifestations and widgets, may be employed in conjunction with one or more operating systems across one or more platforms, as will be apparent to those skilled in the pertinent arts. For example, referring now to the operating system of FIG. 17, the operating system (OS) is generally the software that manages the resources of a computer and provides programmers with an interface to access those resources. An operating system processes system data and user input, and responds by allocating and managing tasks, applications and internal system resources as a service to users and programs of the system. An operating system performs basic tasks such as controlling and allocating memory, prioritizing system requests, controlling input and output devices, facilitating computer networking and managing applications and files. Operating systems as used herein may be found on almost anything made with integrated circuits, such as personal computers, internet servers, cell phones, music players, routers, switches, wireless access points, network storage, game consoles, digital cameras, sewing machines and telescopes.

Referring now to the application space of FIG. 17, application software is a subclass of computer software that employs the capabilities of a computer directly and thoroughly to a task that the user wishes to perform, such as in the performance of the searches discussed hereinabove with respect to FIGS. 1-16. This should be contrasted with system software, which is involved in integrating a computer's various capabilities, but typically does not directly apply them in the performance of tasks that benefit the user. In this context, the term application refers to both the application software and its implementation.

Hyperspace is an operating environment, that is, a layer on top of the BIOS, that may run side-by-side with Windows or another operating system to more efficiently implement some of the most commonly used apps on a PC by instantiating a hypervisor to implement control of certain hardware, such as through a core to the BIOS, and certain software, such as that resident in an application space within the hyper space. There may be several benefits to running and operating in hyperspace. First, moving some of the applications that inadvertently slow down the first operating system, such as Windows for example, such as antivirus and malware-scanning utilities, out of the first operating system altogether and into an application space for such applications within the hyperspace may create efficiency in the first operating system. Such efficiencies may be created by reducing the overhead in the first operating system. Further, the hyperspace may be able reduce the power usage in view of certain uses of the application space, such as through an interaction down through the BIOS to hardware, which may have increased importance particularly in a laptop environment.

A web property may create a neutral platform for consolidation, aggregation and integration of a user's favorite websites, searches, such as those discussed hereinabove with respect to FIGS. 1-16, and web based applications, and may run as an application within the application space. This property may be a webtop which functions and behaves much like a traditional PC desktop.

The present invention may, in any OS, and as one or more applications within any of a desktop, hyperspace, or webtop, provide a lifestyle oriented computing solution that includes search capabilities, and specifically those expert search capabilities discussed hereinabove. More specifically, current home and office computing methodologies provide hardware and software in a relatively “one size fits all” mentality. That is, computers at present provide, at different levels of expense, certain hardware and software capable of performing certain functions and providing certain speeds, memory, and the like, for all purchasers at each price level. Thereby, it is inevitable at each price point in the present computer market that a purchaser will pay for hardware and/or software that he or she does not intend to, and in fact will not, make use of. The present invention provides a lifestyle oriented computing solution in that it provides a cloud computing solution in an open platform format, that is, it provides a computing solution that allows a user to use, and purchase, principally the hardware and only the software that the user will make use of. Further, in the event the purchaser makes a change in the computing that he or she will make use of, the present invention allows for the purchaser to readily and easily modify the initial computing solution to encompass the new need that has arisen.

Thus, in one exemplary embodiment, the present invention may include an open platform computer made up of at least one microprocessor, an encasement for the at least one microprocessor, and at least one operating system resident on the at least one microprocessor. The at least one operating system may include an open platform for accepting a plurality of applications not presented as forming a portion of the at least one operating system. Further, in certain embodiments, the operating system may include one or more search capabilities, either inclusive with the OS or for after market purchase as an application, as discussed hereinbelow, such as for performing expert searches.

There may be any number of ports, such as at least three ports, in the encasement, and the ports may be communicatively electrically connected to the at least one microprocessor. Finally, the at least one of the plurality of applications may be applied at at least one of the ports for presentation by the at least one microprocessor via the at least one operating system.

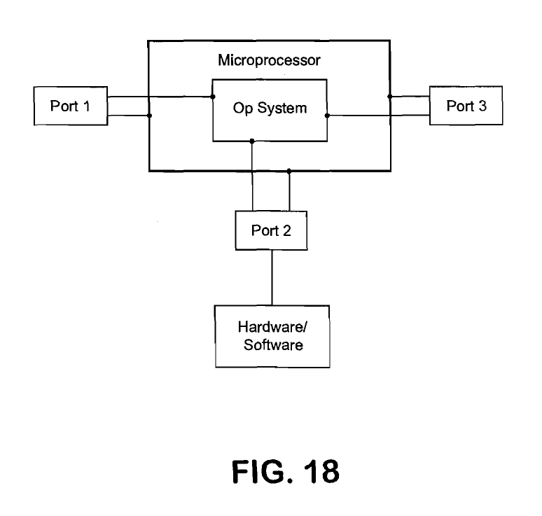

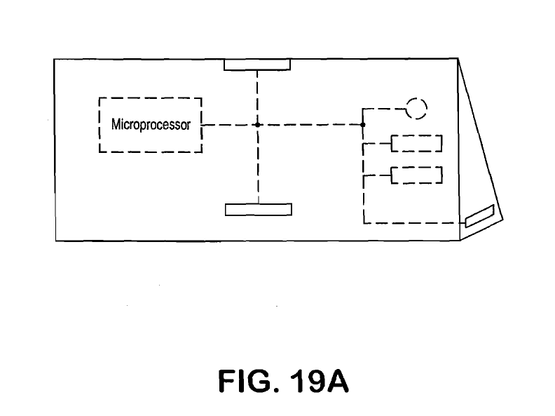

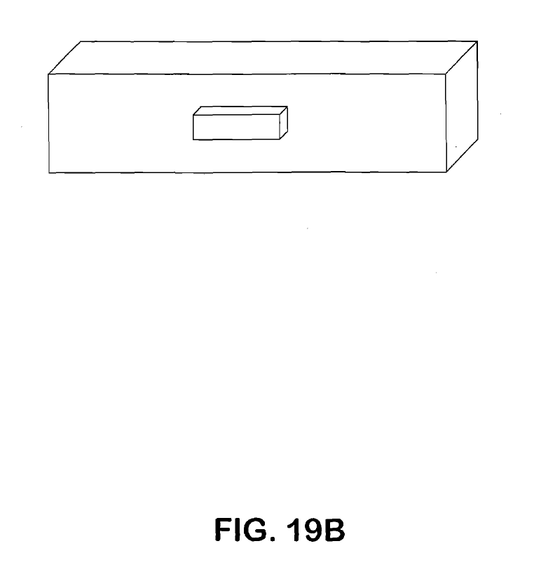

In fact, through the use of the present invention, the purchaser can be provided with solutions other than strictly computing solutions, that is, the user can be provided with replacement technology for other technologies and/or items in and around an office or a household, as will be further explained hereinbelow. More specifically, FIG. 18 illustrates a block diagram of the open platform solution provided by the present invention. FIGS. 19A and 19B illustrate schematic embodiments of the hardware provided by the present invention.

With reference to FIGS. 18, 19A and 19B, the present invention provides a computing solution capable of driving only that hardware, that software, those appliances, and those peripherals desired to be driven by a user of the instant computing solution. Thereby, the present invention provides a modular computing solution that not only introduces modular revenues for the computing industry, but that additionally provides a computing solution that can be developed uniquely by each user for that user's life style profile. For example, modules may be added for use with the present invention that provide internet computing, word processing computing, a set top box, a recipe system for use in a kitchen, or an iPod/MP3 player/radio for use by a swimming pool. Such myriad capabilities may be modularly provided, that is, may be separately made available and/or purchased for use with the initially purchased base computing system.

The base computing system preferably provides an open platform for use in the present invention. The base computing system may be, for example, a Linux based machine, and/or may employ open source software and platforming, and/or may thus provide an openware solution. Such an “open format” computer may provide only that computing desired by the user in a base model computer. Thus, for example, the computing device of the present invention at the base level may be provided with a plurality of USB, Ethernet, RCA, Optical, and like inputs, into which may be connected any number of appliances, peripherals, software modules, and the like. Such input ports may include, for example, a hardware and software port at the top of the unit, in the center and facing upward, ports on the front, sides, back, and even on the stand for the unit, and/or a power port, for example. Any mix of types of such ports, and in any locations, may be provided. Further, an application may, in certain embodiments, entail provision of application software at one port of the present invention, and operation of application specific hardware correspondent to the application software at one or more other ports. Ports may, for the purposes discussed herein, be interchangeable as to what is applied to any given port in a particular application, and may not be interchangeable for the purposes of other application modules. Additionally, the unit may be enabled to operate for periods of time, or permanently, on one or more batteries, rather than a plug-in power supply.

As such, the encasement may have plugged into it, or may itself plug into, one or more appliances or peripherals, via the one or more exposed ports. For example, a lamp base may be created, having therein a “slot” into which the encasement is placed. Upon full insertion into the slot, a port on the encasement may electrically connect with a port within the slot of the lamp, thereby making the microprocessor capable of performing operations on the lamp from within the encasement via the one or more ports.

More specifically, in an exemplary embodiment of the present invention, a user may purchase, inexpensively, such as for ninety-nine dollars, a base computing system. Resident on that base computing system may be only limited operating system software, such as Linux based operating system software, such as a thin client or thick client operating system, such as the UrSpin operating system made by Fuhu. The operating system of the present invention may provide, upon implementation and/or purchase of the computer, no, or very limited, application functionality, and may or may not include search capabilities, and/or one or more search applications. However, the user may be enabled to add on application hardware/software modules to provide functional computing aspects for execution by the open operating system. For example, in certain embodiments, the base computing system may be provided with a computing screen and may otherwise simply be a black box with a plurality of ports therein and a computing screen. The user may purchase a word processing module, wherein, for a limited expense in addition to the base computing system, the user is provided with word processing software for execution with the operating system, along with a computing mouse and keyboard, and/or, in certain embodiments wherein a screen is not provided, a screen having only a USB male connector to mate with a USB female connector at the lower front of the base unit, for example.

Additionally, as mentioned hereinabove, the present invention may provide modular appliance based solutions. For example, the present invention may be purchased as an email module, wherein the machine is dedicated to receiving and sending emails, and wherein the machine includes a foldable screen of any desired size, and a built-in or external keyboard or mouse. However, unlike the prior art, such an email module may be provided as a programmable or non-programmable power strip, and/or in fact may be designed to appear as a lamp base or the like. In such an embodiment, the user may be able to program the power strip to turn the lamp on or off at a desired interval, or may simply use the power strip as connected to a wall switch to turn the lamp on or off. Further, the lamp may be or include a light indicating email has been received, or in fact the machine may turn on the aforementioned lamp when email has been received. Upon receipt or desire to send email, the user may access the small hidden screen and/or keyboard and mouse to engage with the email program, and, after use, may return the hidden items to the appearance of a lamp base. It will be well understood by those skilled in the art that the aforementioned appliance related example is made only by way of example, and that any number of appliance based applications may be indicated in the present invention.

The aforementioned exemplary embodiments are non-limiting. For example, myriad other possibilities for discrete application modules will become apparent to those skilled in the art in light of the disclosure herein, and particularly in light of the type and location of hardware-accepting ports discussed herein. Such applications will include, for example, providing modular applications that provide Internet browsing, email, newspaper(s), telephone, television, alarm clock, and the like.

For the sake of clarity, “applications” as discussed herein are not intended to be, although they may include, merely driver software. For example, the prior art, on occasion, provides a hardware device bundled with driver software, which driver software, when interacted with one or more applications in an operating system in the presence of the hardware that is to make use of the driver software, allows for operation of the hardware by the operating system to occur. However, contrary to the prior art, the present invention provides an operating system that typically does not have an application resident thereon to execute driver software for the hardware of the modules of the present invention. Rather, the present invention provides the necessary hardware, and often the driver software, and the application for interacting with the necessary hardware via the operating system, discretely with each separately obtained bundle.

Due to the module and/or bundled nature of the instant invention, the instant invention provides many advantages over prior art applications. For example, because of the functionality of the instant invention as a dedicated machine dedicated to certain purposes, the instant invention needs only provide sufficient security for the purpose for which the instant invention is being used. For example, for most applications of the present invention, no passwords or other security are necessary, in part because there is little or no information to hack or steal, thereby simplifying use and the speed to which a user can put the instant device to use. Further, the instant invention allows for the addition only of desired modules, or application packs, such as via USB ports. Thereby, through the exposure of one or numerous interface ports, the instant invention allows for the addition of the aforementioned application packs in the form of applications, such as software applications, peripherals, and even appliances, unlike the prior art which limits and/or endeavors to hide the input ports. Further, the present invention is advantageous in that it provides only what a user needs in order to perform the desired functionality, thereby limiting that with which the user needs to interface, and additionally limiting that which the user needs to learn how to operate. Further, the aforementioned modules and/or application packs may be provided with differing elements based on those elements that may make for an improved user experience. For example, a dedicated email machine may be provided with a bigger screen for ease of viewing, and may be provided with a full size keyboard for ease of typing. Further, as mentioned hereinabove, such an email device user need only learn how to use that screen, that keyboard, and that email program, and need not learn about complex unnecessary software, video drivers, and the like.

Further, it will be appreciated by those skilled in the art that the instant invention may provide for a myriad of marketing and sales opportunities. For example, the openware operating system, such as a Linux based operating system, which may be provided on the present device, may, in all or certain embodiments, or bundles, or certain uses, additionally include a preferred search engine, such as the expert search application discussed herein throughout, for which the user may pay a token amount included in or in addition to the low price of the present invention device. Additionally, the present invention may require registration of those bundles, modules, and/or application packs upon purchase by the user, and thus may provide information about the preferences of users, the economics of such users, and the computing usage of such users, for example. Further, because of the open platform solution of the instant invention, any entities may create and/or market modules for use with the instant invention.

As discussed briefly above, the present invention also provides for the purchase of the aforementioned bundles and appliances/peripherals compatible with the base computing system. The base computer system may be bundled with certain applications or peripherals while others may be obtained downstream from the purchase of the base computing system.

In an embodiment of the present invention, the peripherals/appliances/applications compatible with the base computing system may be developed by third party manufacturers, and/or sold by third party manufacturers. By providing such a base computing system and open platform, the present invention allows for the opening of the base computing system to third party suppliers, inventors, entrepreneurs and the like to create, expand, and sell the peripherals/appliances/applications to purchasers and users of the base computing system.

This opening of the base computing system may provide an electronic marketplace which may connect purchasers and users of the base computing system with third party suppliers, including suppliers of hardware, software, appliances, peripherals, toys, and the like. Such a marketplace connection may be made directly through the base computing system, for example, such as through a dedicated marketplace connection that is operable from all base computing systems (but which may, of course, not allow other connectivity unless such connectivity has been purchased), and that may allow the purchaser/user to shop for peripherals/appliances/applications in real time and/or in an incremental manner, if desired.

After purchase, further add-on applications and peripherals may be purchased as needed in accordance with the method of the present invention. For example, a purchaser may also wish to purchase a suite of “office” software which may include, for example, word processing and presentation development software. Such a suite of software may be sold as a stick or chip, for example that would have connectivity with the base computer system. An exemplary form of such a suite peripheral would be in the form of a UBS compatible stick, along with any hardware peripherals needed for operability of the suite. This would allow for the greatest amount of plug and play connectivity. By way of further example, as discussed hereinabove, such connectivity may also be achieved through the use of Bluetooth, Wi-Fi or other wireless connections. Such delivery may also be compatible with RFID, for example.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A dedicated function, modular computing solution, comprising:
a base microprocessing unit;
at least one peripheral interconnective with the base microprocessing unit, wherein the at least one peripheral alone imparts the dedicated function to the base microprocessing unit; and
a limited function operating system provided with the base microprocessing unit, wherein the limited function operating system accepts a first application for at least partially operating the at least one peripheral provided with the at least one peripheral, and wherein the limited function operating system includes a second application for seeking topical information, regarding a topic searched, that is recommended by one or more qualified experts in the topic searched.

2. The dedicated function, modular computing solution of claim 1, wherein said limited function operating system comprises a lifestyle oriented computing solution.

3. The dedicated function, modular computing solution of claim 2, wherein said lifestyle computing solution includes cloud computing.

4. The dedicated function, modular computing solution of claim 2, wherein said lifestyle computing solution is modified to encompass new needs.

5. The dedicated function, modular computing solution of claim 1, wherein said first application for at least partially operating the at least one peripheral is expanded to include at least one subsequent peripheral.

6. The dedicated function, modular computing solution of claim 1, wherein said limited function operating system comprises an open platform.

7. The dedicated function, modular computing solution of claim 6, wherein the open platform is Linux.

8. The dedicated function, modular computing solution of claim 6, wherein the open platform employs open source software.

9. The dedicated function, modular computing solution of claim 1, wherein said limited function operating system comprises a thin client.

10. The dedicated function, modular computing solution of claim 1, wherein said limited function operating system comprises a thick client.

11. The dedicated function, modular computing solution of claim 1, wherein said first application comprises a word processing module.

12. The dedicated function, modular computing solution of claim 1, wherein said first application comprises a modular appliance solution.

13. The dedicated function, modular computing solution of claim 1, wherein said one or more qualified experts comprise verified expertise in the topic searched.

14. The dedicated function, modular computing solution of claim 13, wherein said verified expertise is verified by at least one computing community.

15. The dedicated function, modular computing solution of claim 13, wherein said verified expertise is verified by searching advertisements.

16. The dedicated function, modular computing solution of claim 13, wherein said verified expertise is accorded at least one colored belt based on a level of the verified expertise.

17. The dedicated function, modular computing solution of claim 16, wherein said at least one colored belt is selected from white, green, brown and black.

18. The dedicated function, modular computing solution of claim 17, wherein said white belt represents an introductory level of expertise.

19. The dedicated function, modular computing solution of claim 17, wherein said black belt represents a highest level of expertise.

20. The dedicated function, modular computing solution of claim 1, wherein said second application further comprises an expert's arena providing more than one expert with differing levels of expertise in the topic searched.

21. The dedicated function, modular computing solution of claim 1, wherein said second application further comprises adding at least one keyword to the topic searched in order to increase relevance of search results.

22. The dedicated function, modular computing solution of claim 1, further comprising a tag cloud generated with respect to the topic searched, said tag cloud being associated with said second application.

23. The dedicated function, modular computing solution of claim 22, wherein said tag cloud includes at least one keyword for inclusion in the topic searched to increase relevance of search results.

24. The dedicated function, modular computing solution of claim 22, wherein said tag cloud includes filtering of said topic searched.

25. A method of searching using a modular computing solution, said method comprising:
imparting, by a peripheral interconnective to a microprocessing unit, dedicated functionality to the microprocessing unit;
providing a limited function operating system to the microprocessing unit;
accepting, by the limited function operating system, a first application for at least partially operating at least one peripheral; and
accepting, using a second application of the limited function operating system, a search for topical information that is recommended by one or more qualified experts in the topic searched.

26. The method of claim 25, wherein said limited function operating system comprises a lifestyle oriented computing solution.

27. The method of claim 26, wherein said lifestyle computing solution includes cloud computing.

28. The method of claim 25, further comprising verifying expertise of said one or more qualified experts.

29. The method of claim 28, wherein said verifying comprises verifying by a computing community.

30. The method of claim 29, wherein said verified expertise is accorded at least one colored belt based on the level of expertise.

31. The method of claim 30, wherein said at least one colored belt is selected from white, green, brown and black.

32. The method of claim 31, wherein said white belt represents an introductory level of expertise.

33. The method of claim 31, wherein said black belt represents a highest level of expertise.

34. The method of claim 25, wherein said seeking information comprises a tag cloud generated with respect to said searched topic, said tag cloud being associated with said second application.

35. The method of claim 34, wherein said tag cloud includes at least one keyword for inclusion in the topic searched to increase relevance of search results.

36. The method of claim 34, wherein said tag cloud includes filtering of said topic searched.
